(19) United States
(12) Patent Application Publication
(10) Pub. No.: US 2005/0044446 A1
(43) Pub. Date: Feb. 24, 2005

(54) Method of and device for data backup, and computer product

(75) Inventor: Youichi Sakurai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/786,103

(22) Filed: Feb. 26, 2004

(30) Foreign Application Priority Data
Aug. 20, 2003 (JP) 2003-296156

(51) Int. Cl. G06F 11/00

(52) U.S. Cl. 714/13

(57) ABSTRACT

A data backup device connected to a server via a network includes a usable band detector and a backup controller. The usable band detector detects a width of usable band from an available band of the network. The usable band is band that is currently not being used. The backup controller determines whether the width of usable band is wider than a predetermined width, and transmits data of a client to the server through the network to store the data as backup data in the server when the width of usable band is determined to be wider than the predetermined width.

### BACKGROUND OF THE INVENTION

1) Field of the Invention

The present invention relates to a technology for performing backups of data of a client connected to a server through a network and using the data.

2) Description of the Related Art

Japanese Patent Application Laid Open (JP-A) No. 2002-132717 discloses a technology to store data of a client as backup data in a server connected to the client through a network. The client may be a personal computer or a cellular phone. The technology allows a user to use the backup data if the data of the client is destroyed or when the data is to be transferred to a new machine.

Furthermore, JP-A Nos. 2002-149474 and 2002-215855 disclose technologies to store data of a personal computer in a server to access the data whenever and from wherever a user can use a network.

However, it takes a long time to perform backups of data when the load on the network is heavy and the band is too narrow. Consequently, the performance of applications used in the client is also degraded.

Moreover, not all the backup data are always required when data is to be restored to the client from the server. For example, if user data in a personal computer is inadvertently destroyed, only the user data is required to be restored to the personal computer. If data in an old personal computer is temporarily stored in the server to transfer the data to a new personal computer, it is required to also restore application information such as book marks of a web browser or setting of a mail server. However, in any of these situations, it is not required to restore setting data of operating systems (hereinafter, “OS”).

Since computing resources are used in performing backups, performances of applications are degraded and working efficiency is reduced. Therefore, the frequency of performing backups tends to be decreased.

### SUMMARY OF THE INVENTION

It is an object of the present invention to solve at least the problems in the conventional technology.

A data backup device according to one aspect of the present invention is connected to a server via a network and includes a usable band detector that detects a width of usable band from an available band of the network, the usable band currently not being used; and a backup controller that determines whether the width of usable band is wider than a predetermined width, and transmits data of a client to the server through the network to store the data as backup data in the server when the width of usable band is determined to be wider than the predetermined width.

A backup data management device according to another aspect of the present invention is connected to a client via a network, and includes a backup data storage unit that stores data received from the client through the network as backup data; and a data distributing unit that distributes data specified by the client from the backup data to a destination and at a time both specified by the client.

A data backup method according to still another aspect of the present invention includes detecting a width of usable band from an available band of a network, the usable band currently not being used; determining whether the width of usable band is wider than a predetermined width; and transmitting data of a client to a server through the network to store the data as backup data in the server when the width of usable band is determined to be wider than the predetermined width.

A computer program according to still another aspect of the present invention realizes on a computer the method according to the above aspect.

A data backup system according to still another aspect of the present invention includes a server; and a data backup device connected to the server via a network and including a usable band detector that detects a width of usable band from an available band of the network, the usable band currently not being used, a backup controller that determines whether the width of usable band is wider than a predetermined width, and a transmitter that transmits data through the network to the server to store the data in the server as backup data when the backup controller determines the width of usable band to be wider than the predetermined width.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a functional block diagram of a configuration of a data backup system according to an embodiment of the present invention;

FIG. 2 is a diagram of an example of a data type table created by a data identifying unit;

FIG. 3 is a diagram of types of data determined by a restored data type determining unit;

FIG. 4 is a diagram of an example of a data structure of backup data for each client stored in a backup data storage unit;

FIG. 5 is a diagram of an example of data distribution information;

FIG. 6 is a flowchart of data backup performed by the data backup system according to the embodiment;

FIG. 7 is a flowchart of data restoration performed by the data backup system;

FIG. 8 is a flowchart of data distribution performed by the data backup system; and

FIG. 9 is a block diagram of a hardware configuration of a personal computer that executes a data backup computer program.

### DETAILED DESCRIPTION

Exemplary embodiments of a data backup device, a data backup method, and computer program according to the present invention are explained in detail below with reference to the accompanying drawings. It is noted that a case where the present invention is applied to personal computers is mainly explained as a mere example.

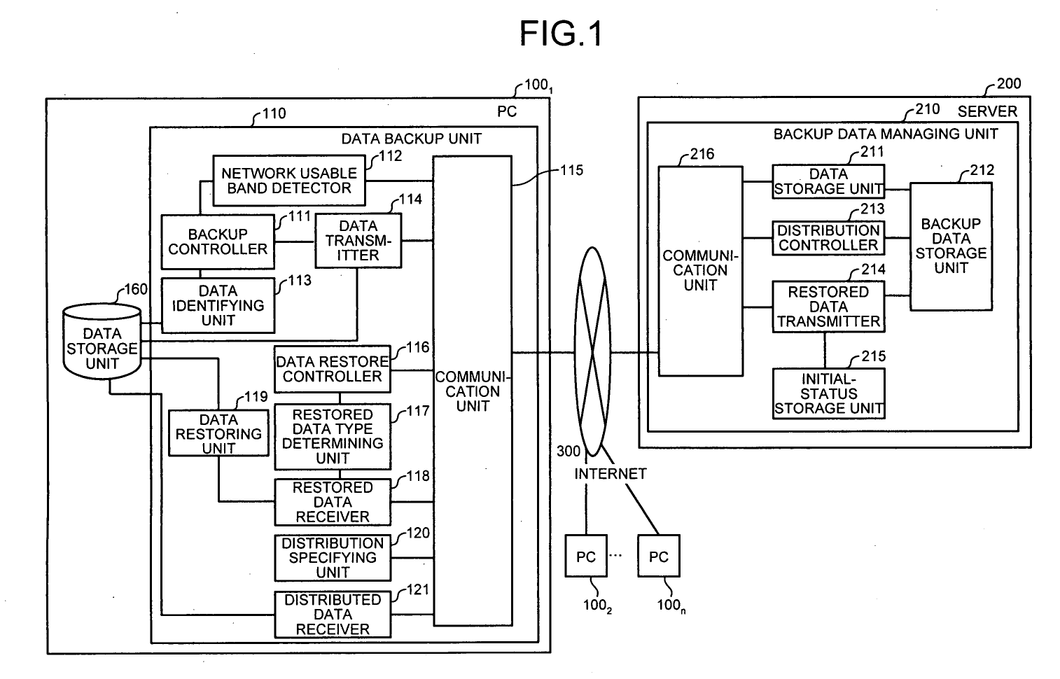

A configuration of a data backup system of an embodiment is explained first. FIG. 1 is a functional block diagram of the configuration. The data backup system includes n personal computers PC 100₁ to PC 100ₙ as devices having data to be backed up as backup data, and a server 200 connected to the devices through the Internet 300. The personal computers PC 100₁ to PC 100ₙ each has a data backup unit 110 configured to perform backups of data. The server 200 has a backup data managing unit 210 configured to manage the backup data.

Although the personal computers are utilized in the embodiment as the devices for the sake of simplicity, any devices having data processing functions, such as celluar phones, personal data assistants (PDA), digital televisions, and communication devices mounted on vehicles, can be used in the data backup system as the devices. Since the PC 100₁ to PC 100ₙ have the same configuration as one another, only the PC 100₁ will be explained in detail below.

The data backup unit 110 of the PC 100₁ includes a backup controller 111, a network usable band detector 112, a data identifying unit 113, a data transmitter 114, a communication unit 115, a data restore controller 116, a restored data type determining unit 117, a restored data receiver 118, a data restoring unit 119, a distribution specifying unit 120, and a distributed data receiver 121.

The backup controller 111 controls transmission of data stored in a data storage unit 160 of the PC 100₁ to the server 200 through the Internet 300 and processing required for performing backups. The processing includes transmission and reception of data.

The network usable band detector 112 detects a width of usable band currently not being used out of an available band between the PC 100₁ and the server 200 through the Internet 300 and transmits the width-of usable band detected to the backup controller 111.

The width of usable band is detected for example using a performance counter of the network interface object if an OS of the PC 100₁ is Windows (registered trademark). The performance counter is a mechanism for collecting performance data related to the system resource.

More specifically, as the performance counter, a counter for bytes total/sec or a counter for a current bandwidth is checked to acquire a currently used band of the network. The currently used band is compared with a network maximum rate of the system property to calculate the usable band.

The width of usable band can also be detected by transmitting and receiving data to and from the server 200 through the communication unit 115. That is, a time between a first point in time at which data with a fixed length is transmitted to the server 200 and a second point in time at which a response from the server 200 is received is measured to calculate the width.

The network usable band detector 112 detects the width of usable band and transmits the width of usable band detected to the backup controller 111. The backup controller 111 then determines whether a backup of data is to be performed, based on the width of usable band received.

The data identifying unit 113 identifies a type of data for each of the data stored in the data storage unit 160. The type of data may be one of user data, OS setting data, application information, and other data. More specifically, the data identifying unit 113 creates a data type table indicating the types of the data identified and transmits the data type table to the backup controller 111.

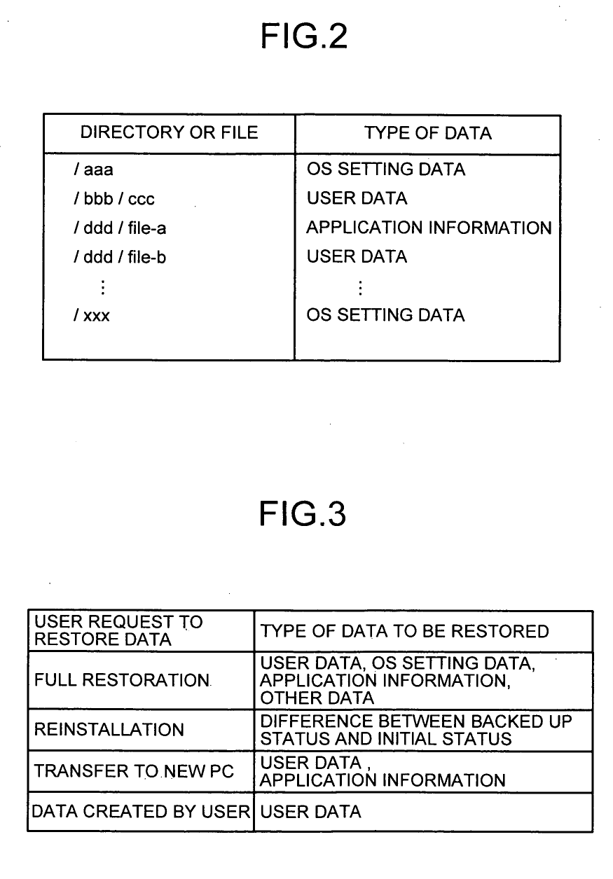

FIG. 2 is a diagram of an example of the data type table. In the data type table, relations of directories or files stored in the data storage unit 160 to the types of data are shown.

For example, the type of data in all the directories and files under a directory “aaa” is the OS setting data, and the type of data in all the directories and files under a directory “bbb/ccc” is the user data. Further, the type of data in a file “file-a” under a directory “ddd” is the application information, and the type of data in a file “file-b” under a directory “ddd” is the user data.

The data transmitter 114 transmits the data identified by the data identifying unit 113 to the server 200 according to the type of data. More specifically, the data transmitter 114 receives the data type table from the backup controller 111 and transmits the data of the types, one type by one type, in an order starting from user data, OS setting data, application information, and then other data, for example, based on the data type table.

The communication unit 115 performs communications with the server 200 through the Internet 300, and notifies the network usable band detector 112 of a load status of the Internet 300.

The data restore controller 116 controls processing for accepting a request to restore data from a user, requesting the server 200 to transmit the data to be restored, and restoring the data to the data storage unit 160.

The restored data type determining unit 117 determines a type or types of data for the data to be restored, based to the request from the user. FIG. 3 is a diagram of the types of data determined by the restored data type determining unit 117.

As shown in FIG. 3, the request from the user may be any of “Full restoration”, “Reinstallation”, “Transfer to new PC”, and “Data created by user”. “PC” here refers to a personal computer.

If the user specifies “Full restoration”, the restored data type determining unit 117 determines that the types of data to be restored are the user data, OS setting data, application information, and other data.

If the user specifies “Reinstallation”, the restored data type determining unit 117 determines that the type of data to be restored is a difference between a backed up status and an initial status of the PC 100₁. The difference here refers to a difference between initial-status master data equivalent to data of the initial status and the backup data both stored in the server 200.

If the user specifies “Transfer to new PC”, the restored data type determining unit 117 determines that the types of data to be restored are the user data and application information. Furthermore, if the user specifies “Data created by user”, the restored data type determining unit 117 determines that the type of data to be restored is the user data.

The data restore controller 116 transmits the request by the user to the restored data type determining unit 117, and requests the server 200 to transmit the data of the type/types of data determined.

Since the data restore controller 116 requests the server 200 to transmit only the data of the type/types, the user can efficiently restore only the data that meets the purpose of restoration.

The restored data receiver 118 receives the backup data transmitted from the server 200 through the Internet 300, via the communication unit 115, and transmits the backup data received to the data restoring unit 119.

The data restoring unit 119 restores the backup data received to the data storage unit 160. That is, the data restoring unit 119 stores the backup data into a file having a file name identical to a file name included in the backup data received.

The distribution specifying unit 120 specifies data to be distributed to another client, from the backup data stored in the server 200. More specifically, the distribution specifying unit 120 receives distribution information from a user and transmits the distribution information to the server 200. The distribution information specifies which of the backup data stored in the server 200 is to be distributed as distributed data, date and time on and at which the distributed data is to be distributed, and destination to which the distributed data is to be distributed. Accordingly, the server 200 is allowed to distribute the distributed data to the destination. As result, the backup data is effectively used by any clients connected to the server 200.

When the user specifies PC 100₁ as the destination and when the distributed data receiver 121 receives the distributed data, the distributed data receiver 121 sends an acknowledgment of the reception back to the server 200, and stores the received distributed data.

The server 200 includes a backup data managing unit 210 that has a data storage unit 211, a backup data storage unit 212, a distribution controller 213, a restored data transmitter 214, an initial-status storage unit 215, and a communication unit 216.

The data storage unit 211 receives the data via the communication unit 216 transmitted from a client such as PC 100₁ through the Internet 300, and stores the data received into the backup data storage unit 212 according to the types of data, one type by one type.

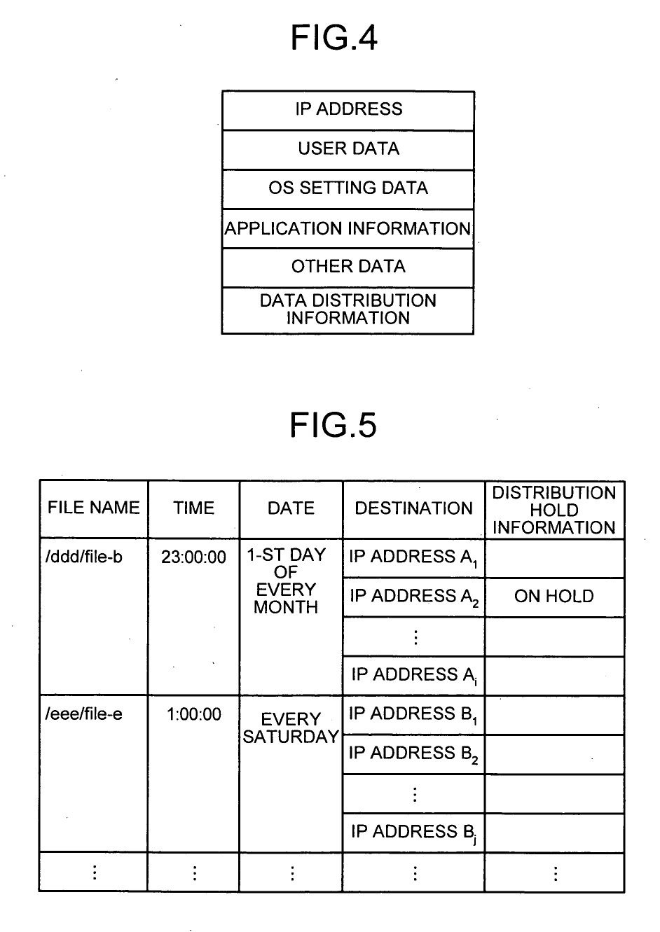

The backup data storage unit 212 stores the data as the backup data. FIG. 4 is a diagram of an example of a data structure of the backup data for each client stored in the backup data storage unit 212. The backup data storage unit 212 stores an IP address, user data, OS setting data, application information, other data, and data distribution information for each client.

The data distribution information is information related to the distributed data, which is the data to be distributed to another client from the backup data. FIG. 5 is a diagram of an example of the data distribution information. The data distribution information includes a file name of the distributed data, a time and date at and on which the distributed data is to be distributed, and destinations which are IP addresses to which the distributed data is to be distributed. The data distribution information is stored for each of the distributed data.

If a client at a destination fails to receive distributed data because of the power of the client being turned off at the time for example, distribution hold information indicating that distribution has been temporarily stopped is stored for that destination of the distributed data.

For example, as shown in FIG. 5, data stored in a file named “/ddd/file-b” is distributed to clients having IP address A₁ to IP address Aᵢ at “23:00:00” on the “1st day of every month”. Data stored in a file named “/eee/file-c” is distributed to clients having IP address B₁ to IP address Bⱼ at “1:00:00” on “Every Saturday”. Distribution to an IP address A₂ of data stored in the file named “/ddd/file-b” has been temporarily stopped or on hold.

The backup data storage unit 212 classifies the backup data for each client into the types of data which are the user data, OS setting data, application information, and other data to store them according to the types. Consequently, only data of the types required by each client can be efficiently transmitted to the client.

The distribution controller 213 distributes the backup data based on the data distribution information stored in the backup data storage unit 212. More specifically, the distribution controller 213 is periodically activated to compare current date and time with the date and time specified in the data distribution information and to determine whether there is any data that has reached the time at which the data should be distributed. If the distribution controller 213 determines that there is data to be distributed at that time, the distribution controller 213 distributes the data to a client specified as the destination of the data distribution information. Furthermore, the distribution controller 213 receives distribution information transmitted from a client and stores the distribution information received as data distribution information into the backup data storage unit 212.

Accordingly, since the distribution controller 213 distributes the backup data based on the data distribution information, a user can effectively utilize the backup data stored in the server 200.

The restored data transmitter 214 transmits the backup data stored in the backup data storage unit 212 in response to a request to restore data from a client such as PC 100₁. The restored data transmitter 214 reads out from the backup data storage unit 212 only data belonging to the type/types of data specified by the client, and transmits the data to the client.

The initial-status storage unit 215 stores the initial-status master data for each client. When the difference between the backed up status and the initial status is specified as the type of data to be restored, the restored data transmitter 214 compares the initial-status master data stored in the initial-status storage unit 215 with the corresponding backup data to obtain the difference. The restored data transmitter 214 then transmits the difference obtained to the PC 100₁.

Accordingly, since the restored data transmitter 214 transmits only the data belonging to the type of data specified by the client, the client can efficiently restore only the data really required.

The communication unit 216 performs communications with a client such as PC 100₁ through the Internet. More specifically, the communication unit 216 transmits and receives the backup data and transmits the distributed data.

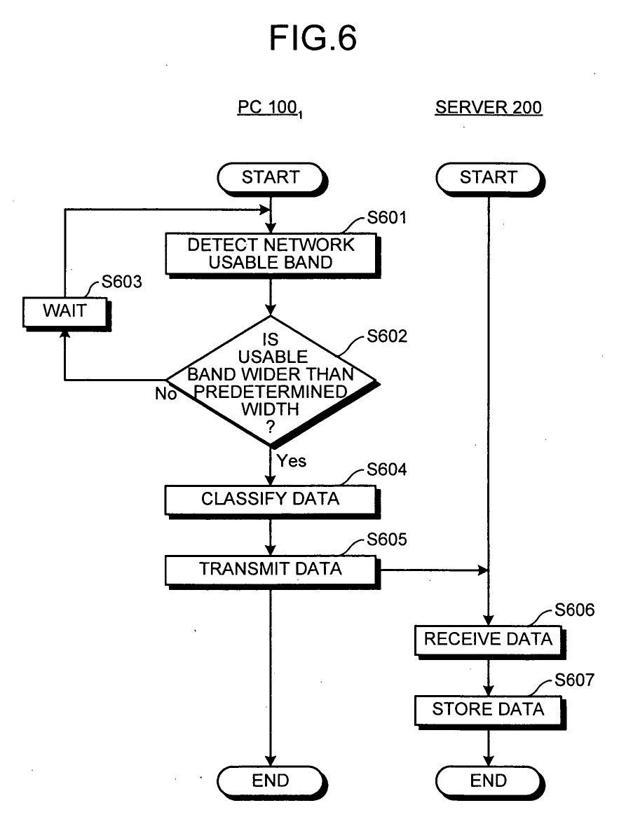

A procedure for performing data backups with the data backup system according to the embodiment is explained below with reference to FIG. 6. FIG. 6 is a flowchart of the procedure.

The data backup unit 110 of the PC 100₁ is activated, and the network usable band detector 112 detects the width of usable band of the Internet 300 based on an instruction by the backup controller 111 (step S601). The data backup unit 110 is automatically activated at any time or frequency specified by the user.

The backup controller 111 checks whether the width of usable band detected is wider than the predetermined bandwidth (step S602). If the available band is narrower than the predetermined bandwidth, the backup controller 111 waits for a predetermined period of time (step S603), and then instructs again the network usable band detector 112 to detect the width of usable band.

On the other hand, if the width of usable band is wider than the predetermined bandwidth, the data identifying unit 113 identifies the type of data for each of the data stored in the data storage unit 160, based on an instruction of the backup controller 111 (step S604). The data identifying unit 113 may store data for which the types of data have been identified such that the data identifying unit 113 can identify the types of data only for those data that has been updated or added the next time a backup is performed.

The backup controller 111 instructs the data transmitter 114 to transmit the data stored in the data storage unit 160 according to the types of data identified to the server 200. The data transmitter 114 in response transmits the data to the server 200 through the communication unit 115 (step S605).

In the server 200, the data storage unit 211 receives the data from the PC 100₁ through the communication unit 216 (step S606), and stores the data received in the backup data storage unit 212 (step S607).

Accordingly, since the network usable band detector 112 detects the width of usable band of the Internet 300 and the backup controller 111 performs back ups of data when the width of usable band detected is wider than the predetermined bandwidth, the data of the PC 100₁ can be efficiently stored in the server 200.

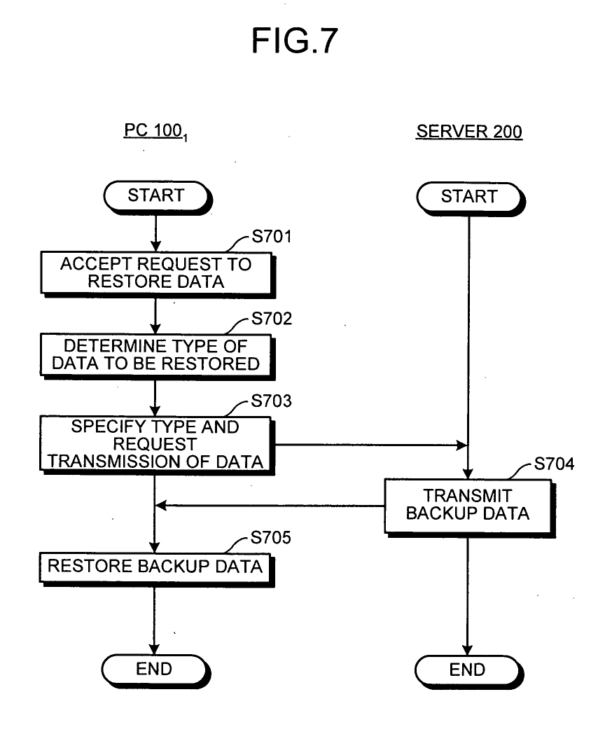

The procedure of data restoration performed by the data backup system according to the embodiment is explained below. FIG. 7 is a flowchart of the procedure.

The data restore controller 116 accepts a request to restore data from a user (step S701), and instructs the restored data type determining unit 117 to determine the type of data to be restored. The restored data type determining unit 117 in response determines the type of data to be restored (step S702). The data restore controller 116 requests the server 200 to transmit data of the type of data determined (step S703).

In the server 200, the restored data transmitter 214 accepts the request, and reads out the data of the type of data determined from the backup data storage unit 212. The restored data transmitter 214 then transmits the data to the PC 100₁ (step S704).

If a difference between the backed up status and the initial status of the PC 100₁ is specified as the type of data to be restored, the restored data transmitter 214 compares the initial-status master data stored in the initial-status storage unit 215 with the backup data stored in the backup data storage unit 212 to obtain the difference, and transmits only the difference to the PC 100₁.

The restored data receiver 118 of the PC 100₁ receives the data to be restored transmitted from the server 200 through the communication unit 115, and transmits the data to the data restoring unit 119. The data restoring unit 119 then restores the data into the data storage unit 160 (step S705).

Accordingly, since the restored data type determining unit 117 determines the type of data to be restored based on the request from the user, and the data restore controller 116 requests the server 200 to transmit only the data of the type of data from the server 200, the restoration of the data to the PC 100₁ can be efficiently performed.

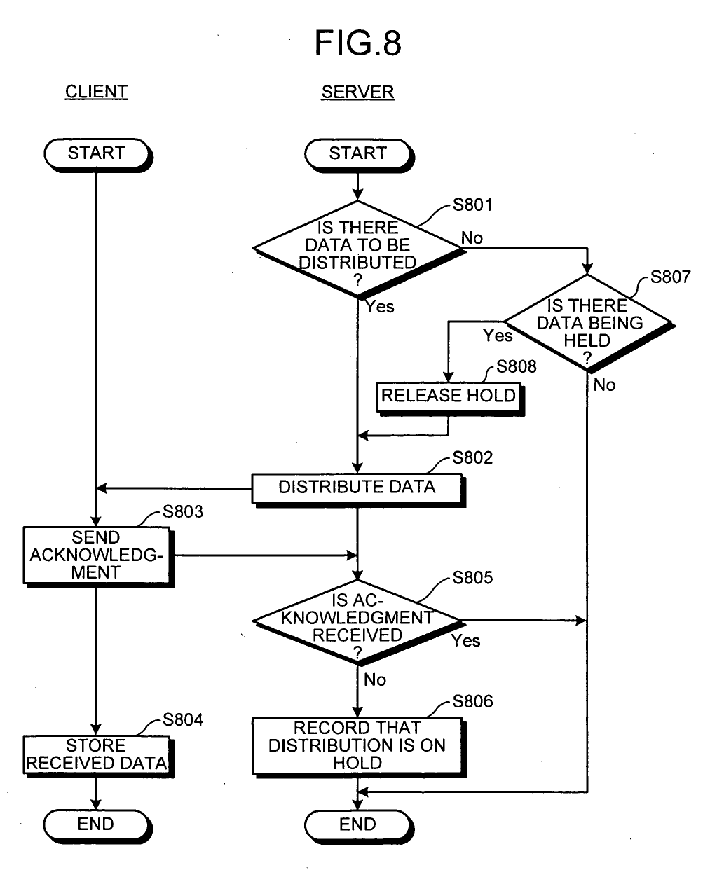

The procedure of data distribution performed by the data backup system according to the embodiment is explained below. FIG. 8 is a flowchart of the procedure.

The distribution controller 213 of the backup data managing unit 210 is activated every predetermined period of time. The distribution controller 213 activated checks whether there is any data from the data stored in the backup data storage unit 212 to be distributed based on the data distribution information also stored in the backup data storage unit 212 (step S801).

If there is data that should be distributed, the data is distributed to a client specified as the destination (step S802). The distributed data receiver 121 of the client receives the data, sends an acknowledgment of reception back to the server 200 (step S803), and stores the data as the distributed data (step S804).

If the acknowledgment is not received from any of the clients specified as the destinations (step S801, No), the distribution controller 213 records that the distribution to that client has been temporarily stopped or on hold in the data distribution information stored in the backup data storage unit 212 (step S806).

If there is no data that should be distributed, the distribution controller 213 determines whether there is any data of which the distribution has been temporarily stopped (step S807). If there is data of which the distribution has been temporarily stopped, the distribution controller 213 cancels the temporary stoppage (step S808), and performs step S802 to distribute the data.

Accordingly, since the distribution controller 213 transmits the specified data from the backup data using the data distribution information stored in the backup data storage unit 212, to the specified destination on and at the specified date and time, and the server 200 has a higher throughput than the PC 100₁, the backup data can be efficiently utilized and distributed from the server 200.

Furthermore, by utilizing and distributing the data stored in the server 200, it is possible to ensure that data is infallibly distributed periodically and distribution of data is prevented from being forgotten. Such distribution of data includes distribution of data such as working data or photographs to be shared with a plurality of users.

As explained above, according to the embodiment, the network usable band detector 112 detects the width of usable band of the Internet 300, and the backup controller 111 performs backups of data when the width of usable band is wider than the predetermined bandwidth. As a result, it is possible to effectively perform the backup and to prevent the reduction in processing efficiency of any other processing being carried out.

Moreover, according to the embodiment, the backup controller 111 classifies the data into the types of data and backs up the classified data to the server 200, and the restored data type determining unit 117 determines the type of data to be restored based on the request from the user. The data restore controller 116 then requests the server 200 to transmit only the data of the type of data determined. Therefore, it is possible to effectively restore only the data that meets the purpose of data restoration.

Furthermore, according to the embodiment, the distribution controller 213 distributes the data specified from the backup data to the destination specified on and at the date and time specified, based on the data distribution information stored in the backup data storage unit 212 that stores the backup data. Accordingly, it is possible to efficiently perform periodical data distributions.

The present invention has been described with the embodiment in which the data to be backed up is classified into the types which are the user data, OS setting data, application information, and other data. However, the present invention is not limited to the embodiment, and is also applicable to, for example, an embodiment in which each of the user data is further classified into a subtype related to an application used to create the user data such as document data or spreadsheet data.

Furthermore, the present invention has been described with the embodiment in which the data backup unit is provided in the PC 100₁ and the backup data managing unit is provided in the server 200. However, the configurations of these data backup unit and backup data managing unit may be realized by software as a data backup computer program and a backup data managing computer program. The configuration of hardware of a personal computer that executes such a data backup computer program is explained below.

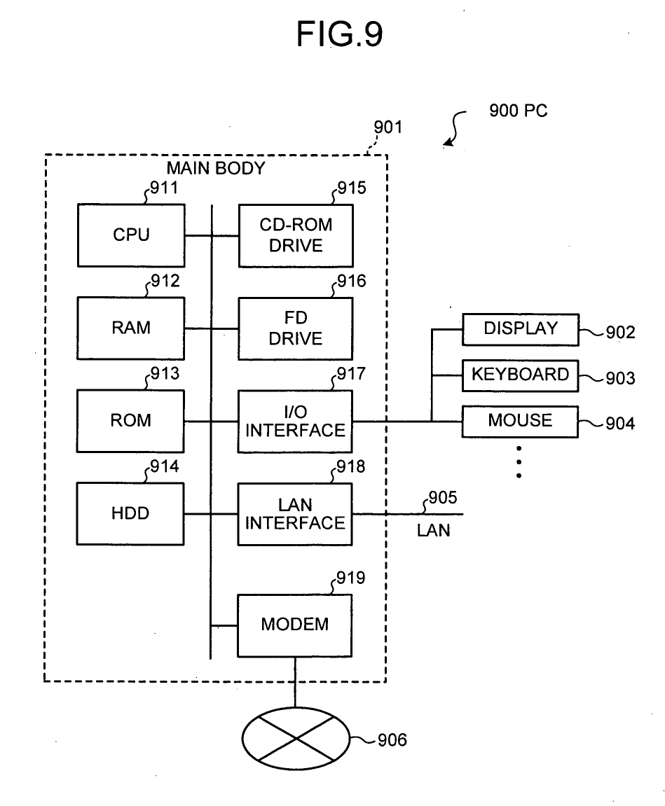

FIG. 9 is a block diagram of the hardware configuration of a personal computer PC 900 that executes the data backup computer program. The PC 900 includes a main body 901, a display 902 that displays information based on an instruction from the main body 901, a keyboard 903 used to enter various information into the PC 900, and a mouse 904 for specifying an arbitrary position on a display screen of the display 902.

The main body 901 includes a central processing unit (CPU) 911, a random access memory (RAM) 912, a read only memory (ROM) 913, a hard disk drive (HDD) 914, a compact disk (CD)-ROM drive 915, a floppy disk (FD) drive 916, an input-output (I/O) interface 917, a local-area network (LAN) interface 918, and modem 919.

The data backup computer program executed on the PC 900 may be stored in any of a portable recording medium such as an FD, a CD-ROM, a digital versatile disk (DVD), a magneto-optical disk, and an integrated circuit (IC) card. The data backup computer program is then read out from the recording medium, and installed in the PC 900.

Alternatively, the data backup computer program may be stored in any of a database of a computer system connected to the PC 900 through the LAN interface 918 and a LAN 905 and a database of a computer system connected through the modem 919 and a public line 906. The data backup computer program is then read out from any of the databases to be installed in the PC 900. The installed data backup computer program is stored in the HDD 914, and executed by the CPU 911 using the RAM 912 and ROM 913.

According to the present invention, when the network is not busy, that is, when the width of usable band of the network is wider than the predetermined width, the data in the client is transmitted to the server to be stored in the server as the backup data. Consequently, it is possible to efficiently perform data backups.

Further, according to the present invention, only the particular types of data actually required can be requested to be transmitted from the server and restored to the client. As a result, it is also possible to efficiently perform data restorations.

Furthermore, according to the present invention, data distributions of the backup data stored in the server can be infallibly and periodically carried out. As a result, it is also possible to efficiently utilize the backup data available, and motivate users to perform backups that have conventionally been bothersome and avoided.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A data backup device connected to a server via a network, comprising:
a usable band detector that detects a width of a usable band from an available band of the network, the usable band currently not being used; and
a backup controller that
determines whether the width of the usable band is wider than a predetermined width, and
transmits data of a client to the server through the network to store the data as backup data in the server when the usable band is determined to be wider than the predetermined width.

2. The data backup device according to claim 1, further comprising:
a data identifying unit that identifies a type of data selected from a plurality of types for each of the data stored in the client, wherein the backup controller specifies the type of each of the data identified when transmitting each of the data to the server; and
a data restoring unit that
receives a request from a user of the client,
determines a type of backup data to be obtained from the backup data stored in the server according to the type, based on the request, the type of backup data being one of the types,
requests the server to transmit the backup data of the type determined,
receives the backup data of the type transmitted from the server, and
restores to the client the backup data of the type received.

3. The data backup device according to claim 2, wherein the types are user data, operating system setting data, application information, and other data.

4. The data backup device according to claim 1, further comprising a data restoring unit that
receives an initial state restore request from a user to restore data of an initial state of the client,
requests the server to transmit a difference between the backup data and an initial state master data both stored in the server, and
receives the difference from the server to restore the difference to the client.

5. The data backup device according to claim 1, further comprising:
a distribution specifying unit that receives distribution information from a user and transmits the distribution information to the server, wherein the distribution information specifies
distributed data to be distributed from the backup data stored in the server to another client via the network,
a time at which the distributed data is to be distributed, and
a destination to which the distributed data is to be distributed.

6. A backup data management device connected to a client via a network, comprising:
a backup data storage unit that stores data received from the client through the network as backup data; and
a data distributing unit that distributes data specified by the client from the backup data to a destination and at a time both specified by the client.

7. The backup data management device according to claim 6, wherein the backup data storage unit classifies each of the data according to a type specified by the client.

8. A data backup method comprising:
detecting a width of usable band from an available band of a network, the usable band currently not being used;
determining whether the width of usable band is wider than a predetermined width; and
transmitting data of a client to a server through the network to store the data as backup data in the server when the width of usable band is determined to be wider than the predetermined width.

9. The data backup method according to claim 8, further comprising:
identifying a type of data selected from a plurality of types for each of the data stored in the client;
specifying the type of each of the data identified when transmitting each of the data to the server;
receiving a request from a user of the client;
determining a type of backup data to be obtained from the backup data stored in the server according to the type, based on the request, the type of backup data being one of the types;
requesting the server to transmit the backup data of the type determined;
receiving the backup data of the type transmitted from the server; and
restoring to the client the backup data of the type received.

10. A computer readable recording medium that stores a computer program including computer executable instructions which when executed by a computer, cause the computer to perform:
detecting a width of usable band from an available band of a network, the usable band currently not being used;
determining whether the width of usable band is wider than a predetermined width; and
transmitting data of a client to a server through the network to store the data as backup data in the server when the width of usable band is determined to be wider than the predetermined width.

11. A data backup system comprising:
a server; and
a data backup device connected to the server via a network and including
a usable band detector that detects a width of usable band from an available band of the network, the usable band currently not being used,
a backup controller that determines whether the width of usable band is wider than a predetermined width, and
a transmitter that transmits data through the network to the server to store the data in the server as backup data when the backup controller determines the width of usable band to be wider than the predetermined width.

12. The data backup system according to claim 11, further comprising a memory unit that stores the data, wherein
the data backup device further comprises a data identifying unit that identifies a type of data selected from a plurality of types for each of the data stored in the memory unit, and
the transmitter transmits each of the data to the server according to the type identified by the data identifying unit.

13. The data backup system according to claim 12, wherein the data backup device further comprises a data restoring unit that
receives a request from a user,
determines a type of backup data to be obtained from the backup data stored, based on the request, the type being one of the types,
requests the server to transmit the backup data of the type determined,
receives the backup data of the type transmitted, and
restores to the memory unit the backup data of the type received.

14. The data backup system according to claim 12, wherein the types are user data, operating system setting data, application information, and other data.

15. The data backup system according to claim 11, further comprising a client connected to the network, the client including the backup device.

16. The data backup system according to claim 12, wherein the server comprises a backup data storage unit that stores, as the backup data, each of the data transmitted from the backup controller according to the type.

17. The data backup system according to claim 15, wherein
the server comprises an initial state storage unit that stores initial state master data of the client, and
the data backup device further comprises a data restoring unit that
receives an initial state restore request from a user to restore data of an initial state of the client,
requests the server to transmit a difference between the backup data and the initial state master data, and
receives the difference from the server to restore the difference to the client.

18. The data backup system according to claim 15, wherein
the client further comprises a distribution specifying unit that receives distribution information from a user and transmits the distribution information to the server, the distribution information that specifies distributed data to be distributed from the backup data stored in the server to another client via the network, a time at which the distributed data is to be distributed, and a destination to which the distributed data is to be distributed, and
the server further comprises a data distributing unit that distributes the distributed data from the backup data to the destination and at the time based on the distribution information.
